(19) United States
(12) Patent Application Publication
(10) Pub. No.: US 2025/0315688 A1
(43) Pub. Date: Oct. 9, 2025

(54) System and Method for Distilling at Least One Foundation AI Model into Embedded Micro-Models with Telemetry-Guided Runtime Adaptation, Self-Learning, and Equivalent or Similar Functionality in Constrained or Hybrid Environments

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 19/242,792

(22) Filed: Jun. 18, 2025

(51) Int. Cl. G06N 3/096; G06N 3/0495

(52) U.S. Cl. CPC G06N 3/096; G06N 3/0495

(57) ABSTRACT

A system and method are disclosed for transforming at least one foundation artificial intelligence (AI) model into one or more embedded micro-models configured for deployment in constrained or hybrid computing environments. Each micro-model is packaged within a structured container that includes inference logic, metadata, telemetry thresholds, and fallback logic. A runtime engine monitors execution conditions and adaptively switches among inference logics or activates fallback behavior based on telemetry signals such as CPU load, memory usage, latency, or confidence score. The system supports operation on OS-less or minimal-runtime platforms and enables distributed deployment across mesh networks using multiple communication protocols. Micro-models may coordinate autonomously or under supervisory guidance and are executed within multi-dimensional or non-topological configurations. The invention enables scalable, resilient AI inference in embedded systems with limited resources.

### CROSS-REFERENCE TO RELATED APPLICATIONS

### US Patent Documents

U.S. Pat. No. 11,983,630 B2 05/2024 Iandola et al.

U.S. Pat. No. 10,188,296 B2 01/2019 AI—Ali et al.

U.S. Pat. No. 9,775,520 B2 10/2017 Tran

### Other Publication

Benoit Jacob et al. “Quantization and Training of Neural Networks for Efficient Integer-Arithmetic-Only Inference”. Proceedings of the IEEE Conference on Computer Vision and Pattern Recognition (CVPR), 2018, pp. 2704-2713

Zhenhua Liu et al. “Instance-Aware Dynamic Neural Network Quantization”. Proceedings of the IEEE/CVF Conference on Computer Vision and Pattern Recognition (CVPR), 2022, pp. 12434-12443

### BACKGROUND OF THE INVENTION

Foundation artificial intelligence (AI) models, including transformer networks, convolutional neural networks, and multimodal architectures, have demonstrated strong performance across a variety of cognitive tasks such as classification, prediction, reasoning, and planning. Despite their effectiveness, these models are typically large, computationally intensive, and energy demanding, which makes them unsuitable for direct deployment on embedded systems or other constrained hardware platforms commonly found in edge computing environments.

To address these limitations, existing model optimization techniques such as quantization and pruning have been developed to reduce the size and complexity of AI models. However, these methods alone do not resolve several critical challenges associated with real-world deployment in embedded or hybrid systems. For example, they do not provide structured packaging of inference models that are optimized for minimal or OS-less runtime environments. They also lack mechanisms to enable telemetry-guided switching among different inference logic types based on resource constraints or execution context.

In addition, current approaches do not offer support for local or distributed fallback mechanisms that are responsive to dynamic execution conditions. Communication among deployed models is often limited in scope, with insufficient support for multi-protocol interoperability across wired, wireless, or hybrid mesh networks. This lack of protocol abstraction prevents dynamic AI coordination across heterogeneous devices.

Existing systems also do not accommodate autonomous or peer-based operation within distributed AI topologies. They offer limited or no support for supervisory interaction with one or more foundation models that could provide updates, model refinements, or high-level policy synchronization. Furthermore, many available solutions do not support scalable architectures that allow one-to-one or one-to-many distillation of micro-models tailored to specific roles within a system.

Finally, current solutions are not designed to operate within multi-dimensional topologies or non-topological execution arrangements such as stateless peer clusters or cyclic mesh graphs. This further limits their adaptability in dynamic or resource-variable environments.

Accordingly, there is a need for a unified system that can transform at least one foundation AI model into one or more lightweight, runtime-adaptive micro-models, each capable of functioning within constrained, embedded, or hybrid networked systems. The system should include containerized packaging, support for telemetry-guided switching and fallback logic, compatibility with multiple communication protocols, and flexibility for deployment across distributed topologies. The present invention addresses these unmet needs by providing a modular and scalable architecture for resilient and efficient AI execution in real-time and resource-constrained environments.

### SUMMARY OF THE INVENTION

The present invention provides a system and method for distilling at least one foundation AI model into at least one embedded micro-model that is configured for execution within constrained, embedded, or equivalent computing environments. Each micro-model is encapsulated within a structured execution container and is optimized for runtime adaptation and fallback. These micro-models may operate within multi-dimensional topologies or non-topological coordination structures, allowing flexible and resilient deployment across a range of operational contexts.

The invention includes a distillation engine that supports both one-to-one and one-to-many transformation of foundation models into sub-models. These sub-models are selected or generated based on functional role-specific behaviors, enabling task-specific optimization. Each resulting micro-model is packaged within a structured container format, such as the .micai format, which incorporates the inference logic, role metadata, telemetry thresholds, fallback logic, compatibility scoring, and version tracking.

A runtime execution engine is provided to interpret and manage the containerized micro-model. This runtime engine is capable of switching between neural, non-neural, symbolic, or equivalent inference logic types in response to dynamic telemetry conditions, such as CPU usage, memory load, inference latency, model confidence, and environmental variation. The system is designed to operate with or without a conventional operating system and supports minimal embedded runtime environments.

The communication infrastructure within the invention supports distributed deployment of micro-models using at least one or more wired, wireless, or hybrid communication protocols. These may include, but are not limited to, Bluetooth Low Energy (BLE), Wi-Fi, Thread, Zigbee, LoRa, Ultra-Wideband (UWB), cellular networks such as LTE, 5G or 6G, Ethernet, Controller Area Network (CAN) bus, Power Line Communication (PLC), optical fiber, satellite links, or any equivalent or similar protocol. The system enables peer-to-peer coordination among deployed micro-models and allows propagation of fallback events or telemetry status across nodes. In some configurations, the micro-models may optionally interact with at least one supervisory foundation model to support model refinement, learning synchronization, or policy updates. The execution of micro-models can take place within various coordination structures, including hierarchical networks, mesh clusters, stateless fallback swarms, or cyclic peer graphs. This topology flexibility allows runtime behavior to adapt based on context, telemetry metrics, task priority, and network state.

The present invention may be applied to, but is not limited to, a wide range of use cases involving real-time control, monitoring, classification, anomaly detection, decision assistance, and other intelligent functions in embedded, distributed, or hybrid systems. The invention enables scalable, resilient AI execution in environments where computational resources, connectivity, or responsiveness may be limited or highly variable.

### BRIEF DESCRIPTION OF DRAWINGS

FIG. 1—System Architecture Overview

FIG. 2—Foundation Model Distillation Flow

FIG. 3—Micro-Model Container Structure for Embedded Inference Deployment

FIG. 4—Telemetry-Based Execution Switching Logic

FIG. 5—Embedded Execution Without Operating System

FIG. 6—Mesh-Based Distributed Micro-Model Deployment

### DETAILED DESCRIPTION OF THE INVENTION

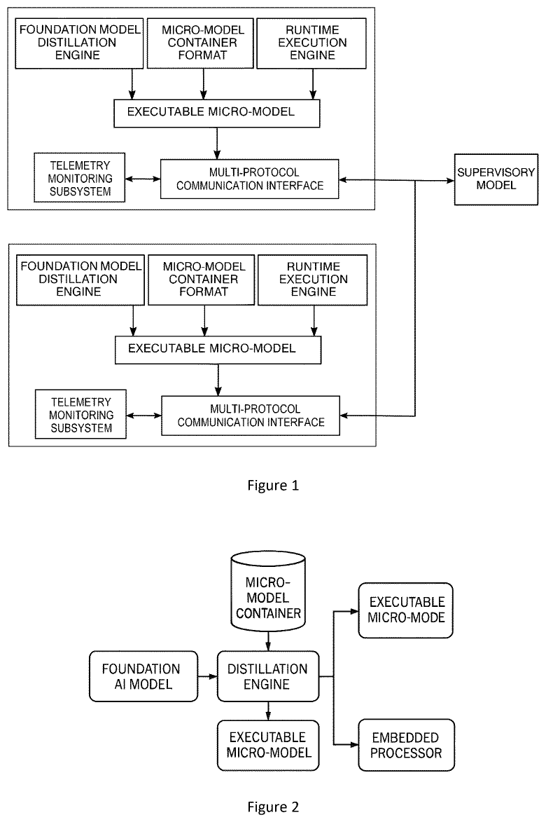

Referring now to FIG. 1, the system architecture comprises multiple functional components, including a foundation model distillation engine, a micro-model container format, a runtime execution engine, a telemetry monitoring subsystem, and a multi-protocol communication interface. The system enables the transformation of at least one foundation artificial intelligence model into one or more executable micro-models suitable for operation on embedded processors, edge devices, or functionally equivalent constrained environments. Each micro-model is configured to execute independently or in coordination with other micro-models and may interact with supervisory models for policy synchronization or model refinement.

As shown in FIG. 2, the distillation process begins with the selection of at least one foundation model. This model is decomposed into one or more functional subcomponents based on task-specific behavior, operational role, or inference requirements. The relevant subcomponents are then compressed or transformed using techniques such as quantization, pruning, symbolic logic translation, or other equivalent model optimization methods. Each resulting micro-model is assigned a functional role and packaged into a structured container for deployment. The distillation process may support one-to-one transformation, where a single micro-model reflects the foundation model's entire behavior, or one-to-many distillation, where the model is decomposed into a group of micro-models operating in coordination.

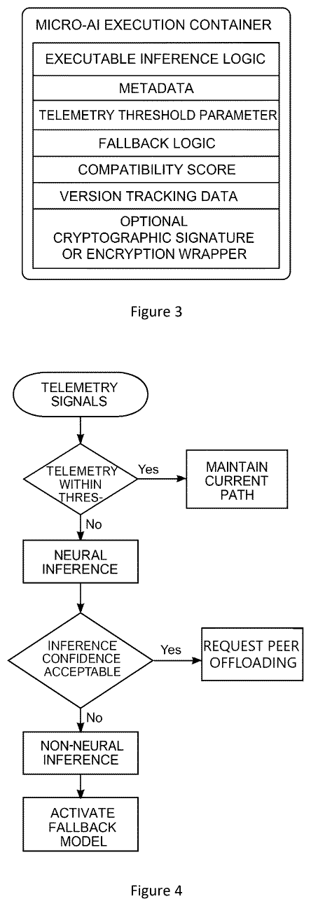

FIG. 3 illustrates the structure of the Micro-AI Execution Container, also referred to as the MICAI format. Each container includes the executable inference logic, which may be based on a neural network, rules-based algorithm, symbolic model, or any equivalent or similar logic. The container further encapsulates metadata describing the execution role of the micro-model, telemetry threshold parameters, fallback logic, a compatibility score based on device capabilities, version tracking data, and optionally a cryptographic signature or encryption wrapper. The structure supports deployment to a wide range of devices by providing explicit runtime compatibility indicators and fail-safe mechanisms.

At runtime, as illustrated in FIG. 4, each micro-model is managed by an embedded execution engine that interprets telemetry signals to determine appropriate behavior. The runtime engine may operate with or without a full operating system and monitors various indicators including CPU load, memory availability, inference latency, model confidence, GPU usage, and environmental sensor data. When telemetry conditions exceed or fall below defined thresholds, the runtime engine may initiate a logic switch between neural, non-neural, or symbolic inference paths. It may also activate a fallback model, request offloading to a peer node, or issue a supervisory refinement request. This enables adaptive behavior that responds to real-time conditions without centralized orchestration.

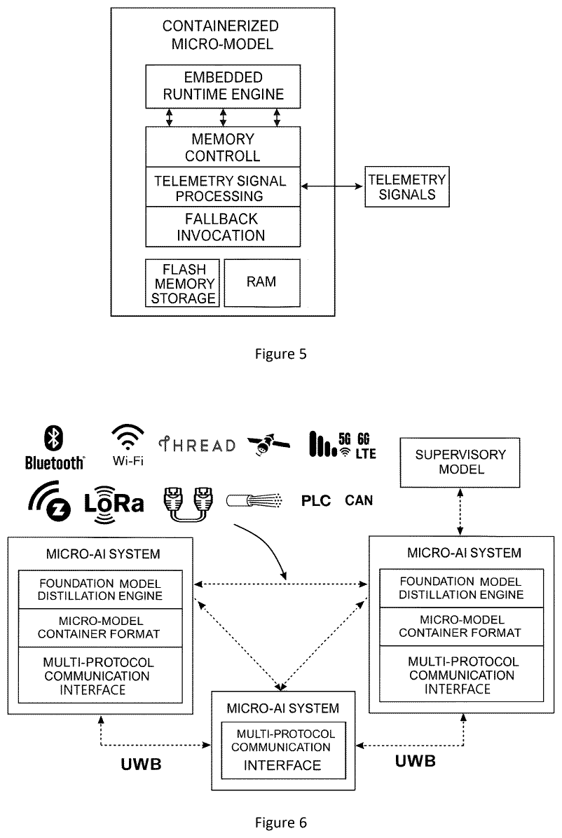

FIG. 5 demonstrates execution of the system in an OS-less or minimal runtime embedded environment. The containerized micro-model executes directly on the hardware without relying on full-featured operating systems. In such configurations, the runtime engine must manage all aspects of memory control, telemetry signal processing, and fallback invocation. This arrangement is optimized for systems with limited flash memory and RAM, and may be deployed in sensor nodes, microcontrollers, or energy-constrained platforms such as wearable or battery-operated devices.

As shown in FIG. 6, the invention supports distributed deployment of micro-models across a mesh or hybrid network using multiple wired or wireless communication protocols. The communication interface allows operation over Bluetooth Low Energy (BLE), Wi-Fi, Thread, Zigbee, LoRa, Ultra-Wideband (UWB), LTE, 5G, 6G, Ethernet, CAN bus, Power Line Communication (PLC), optical fiber, satellite, or any equivalent or similar protocol. Within the mesh, micro-models may share telemetry signals, execution status, fallback triggers, and compatibility information. Peer nodes may coordinate their behavior through protocol-abstracted messaging layers, allowing fallback logic to propagate dynamically throughout the network. Supervisory models may optionally provide oversight by issuing updates or policy synchronization signals to nodes within the mesh. This enables real-time distributed coordination without requiring a persistent cloud connection.

The micro-models may be deployed within a variety of topologies, including hierarchical controller-sensor-actuator chains, symmetric peer clusters, broadcast-only fallback swarms, cyclic graphs, and stateless coordination networks. These topologies may be physical or logical, and their structure may evolve at runtime based on task context, telemetry measurements, or network changes. In this way, the invention supports adaptive, resilient artificial intelligence execution within constrained, distributed, and hybrid environments.

The present invention may be applied to, but is not limited to, automated or semi-automated tasks such as real-time sensing, decision-making, classification, control, monitoring, prediction, anomaly detection, or cooperative actuation. It enables embedded AI deployment in environments where compute, power, connectivity, or response latency may be limited or highly variable. The architecture supports scalable execution, safe fallback behavior, and telemetry-driven adaptation, ensuring continuity and performance in mission-critical or resource-constrained scenarios.

1. A system for executing at least one embedded AI micro-model in a constrained or equivalent or similar functionality environment, comprising:
a distillation engine configured to transform at least one foundation AI model into at least one micro-model, wherein the transformation supports one-to-one or one-to-many decomposition;
a container structure encapsulating the micro-model, the container comprising inference logic based on at least one of a neural network, non-neural algorithm, symbolic logic, or equivalent or similar functionality, and further comprising metadata specifying execution role, telemetry thresholds, and fallback logic;
a runtime engine deployed in an embedded or equivalent processing unit and configured to evaluate telemetry data including at least one of CPU load, memory usage, inference latency, model confidence, GPU utilization, or environmental variance, and further configured to switch between micro-models or activate fallback logic based on telemetry conditions;
a communication module enabling distributed operation across at least one wired, wireless, or hybrid mesh network using at least one or more communication protocols selected from Bluetooth Low Energy (BLE), Wi-Fi, Thread, Zigbee, LoRa, Ultra-Wideband (UWB), cellular (including LTE, 5G, or 6G), Ethernet, Power Line Communication (PLC), Controller Area Network (CAN) bus, optical fiber, satellite links, or any equivalent or similar functionality protocol;
wherein the micro-model is executed within at least one multi-dimensional topology or non-topological coordination structure.

2. The system of claim 1, wherein the telemetry engine further considers GPU or equivalent hardware accelerator utilization when evaluating execution switching or fallback.

3. The system of claim 1, wherein the fallback logic includes symbolic inference, heuristic decision trees, or rules-based processing modules.

4. The system of claim 1, wherein the container metadata includes a compatibility score based on available device resources and assigned role.

5. The system of claim 1, wherein at least one micro-model is executed in an OS-less environment or equivalent minimal runtime context.

6. The system of claim 1, wherein multiple micro-models operate independently or collaboratively within a distributed mesh, and optionally synchronize with a supervisory foundation model for remote refinement or policy updates.

7. The system of claim 1, wherein micro-models form dynamic execution clusters based on task context, telemetry similarity, or mesh topology configuration.

8. The system of claim 1, wherein peer micro-models exchange telemetry signals, execution status, fallback triggers, or compatibility scores for coordinated adaptation.

9. The system of claim 1, wherein fallback behavior activated on one node propagates cooperative fallback across at least one peer node within the distributed mesh.

10. The system of claim 1, wherein the container includes at least one cached symbolic logic path or minimal fallback model stored in persistent memory for local recovery.

11. The system of claim 1, wherein the runtime engine concurrently manages execution of multiple containers and selects or switches among them based on telemetry performance scoring.

12. The system of claim 1, wherein the embedded processor executing the micro-model is a constrained or equivalent processing platform, including but not limited to devices with less than 1 MB of flash memory and less than 256 KB of RAM, or any functionally similar architecture.

13. A method for distilling and deploying at least one AI micro-model derived from a foundation model, comprising the steps of:
selecting at least one foundation model based on task requirements;
extracting at least one functional component based on relevance to a role;
compressing said component using at least one of quantization, pruning, symbolic translation, or an equivalent or similar functionality transformation;
packaging the resulting micro-model into a structured container including metadata, telemetry thresholds, execution role, and fallback logic;
deploying said container to a processor operating within a constrained or equivalent or similar functionality environment;
executing said micro-model within a runtime engine that monitors telemetry including but not limited to CPU usage, inference latency, memory load, model confidence, or network quality;
dynamically switching inference logic or activating fallback logic based on said telemetry;
coordinating said execution within at least one multi-dimensional topology or non-topological arrangement using at least one communication protocol selected from: BLE, Wi-Fi, Thread, Zigbee, LoRa, UWB, LTE, 5G, 6G, Ethernet, PLC, CAN, optical fiber, satellite, or equivalent or similar functionality protocol.

14. The method of claim 13, wherein multiple micro-models are derived from a single foundation model and deployed for roles including but not limited to sensing, control, decision making, or coordination.

15. The method of claim 13, further comprising encrypting the micro-model container and verifying authenticity before execution using digital signatures or hardware-based keys.

16. The method of claim 13, wherein fallback logic is triggered upon exceeding at least one defined threshold for latency, thermal condition, inference confidence, or communication quality.

17. The method of claim 13, wherein telemetry includes sensor input reflecting environmental variance, including but not limited to temperature, humidity, vibration, or electromagnetic interference.

18. The method of claim 13, further comprising dynamically reassigning execution roles among distributed micro-models based on runtime telemetry, hardware availability, or task priority.

19. A method for distilling and deploying at least one AI micro-model derived from a foundation model, comprising the steps of:
selecting at least one foundation model based on task requirements;
extracting at least one functional component based on relevance to a role;
compressing said component using at least one of quantization, pruning, symbolic translation, or an equivalent or similar functionality transformation;
packaging the resulting micro-model into a structured container including metadata, telemetry thresholds, execution role, and fallback logic;
deploying said container to a processor operating within a constrained or equivalent or similar functionality environment;
executing said micro-model within a runtime engine that monitors telemetry including but not limited to CPU usage, inference latency, memory load, model confidence, or network quality;
dynamically switching inference logic or activating fallback logic based on said telemetry;
coordinating said execution within at least one multi-dimensional topology or non-topological arrangement using at least one communication protocol selected from: BLE, Wi-Fi, Thread, Zigbee, LoRa, UWB, LTE, 5G, 6G, Ethernet, PLC, CAN, optical fiber, satellite, or equivalent or similar functionality protocol.

20. The medium of claim 19, wherein the container metadata includes version history, refinement timestamp, model hash, and device-specific deployment signature.
